(19) United States
(12) Patent Application Publication
(10) Pub. No.: US 2017/0248108 A1
(43) Pub. Date: Aug. 31, 2017

(54) Fuel Rail Assembly for an Internal Combustion Engine

(71) Applicant: CONTINENTAL AUTOMOTIVE GMBH, Hannover (DE)

(72) Inventors: Gisella Di Domizio, San Giuliano Terme (IT); Massimo Latini, Empoli (FI) (IT); Marco Pasquali, Livorno (IT); Georg Weigl, Regensburg (DE)

(73) Assignee: CONTINENTAL AUTOMOTIVE GMBH, Hannover (DE)

(21) Appl. No.: 15/593,836

(22) Filed: May 12, 2017

Related U.S. Application Data
(63) Continuation of application No. PCT/EP2015/076457, filed on Nov. 12, 2015.

(30) Foreign Application Priority Data
Nov. 19, 2014 (EP) 14193839.9

(51) Int. Cl. F02M 55/02; F02M 61/16; F02M 69/50; F02M 55/00

(52) U.S. Cl. CPC F02M 55/025; F02M 55/005; F02M 61/168; F02M 69/50; F02M 2200/803; F02M 2200/8084; F02M 2200/856; F02M 2200/857

(57) ABSTRACT

A fuel rail assembly is disclosed. The fuel rail assembly includes an elongated tubular fuel rail and a plurality of fuel delivery lines for hydraulically coupling the fuel rail to fuel injectors. Each fuel delivery line has an injector cup, a pipe being arranged between the fuel rail and the injector cup, and a fixation bracket. A rigid connection is established between the fixation bracket and a portion of the pipe, the portion being spaced apart from each of the fuel rail and from the injector cup.

The injector cup, the pipe, and the fixation bracket are individual parts. The fixation bracket is spaced apart from the injector cup and from the fuel rail.

### CROSS REFERENCE TO RELATED APPLICATIONS

This U.S. patent application claims the benefit of PCT patent application No. PCT/EP2015/076457, filed Nov. 12, 2015, which claims the benefit of European patent application No. 14193839.9, filed Nov. 19, 2014, all of which are hereby incorporated by reference herein.

### FIELD OF INVENTION

The present disclosure relates to a fuel rail assembly for an internal combustion engine.

### BACKGROUND

Fuel rails, in particular for gasoline direct injection engines are usually designed according to the engine packaging of the specific internal combustion engine. Usually, the design of the fuel rail is specific to a particular engine and unusable for other engines.

### SUMMARY

It is an object of the present disclosure to specify a fuel rail which is easily configurable during production for use with engines of different shapes and/or which is particularly cost effective.

According to one aspect, a fuel rail assembly for an internal combustion engine is specified. According to a second aspect, a method for manufacturing the fuel rail assembly is specified.

The fuel rail assembly comprises an elongated tubular fuel rail. The elongated tubular fuel rail is in particular a tubular fuel reservoir. Preferably, the elongated tubular fuel rail is a straight tube. The fuel rail is in particular made of a metal or an alloy.

Preferably, fuel is supplied under high pressure into the fuel rail, in particular by a fuel pump, and stored in the fuel rail for being dispensed into the internal combustion engine by a plurality of fuel injectors. The fuel injectors are in particular operable to inject the fuel directly into respective combustion chambers of the combustion engine.

The fuel rail assembly has a plurality of fuel delivery lines for hydraulically coupling the fuel rail to the fuel injectors which are operable to inject fuel into combustion engine. Each of the fuel delivery lines branches off from the fuel rail. Each of the fuel delivery lines is in particular assigned to one and only one of the injectors.

In the following, only one of the fuel delivery lines is described in detail. However, the fuel delivery lines are preferably of identical type. The fuel delivery lines may be arranged sequentially or subsequently to one another along an elongation direction of the tubular fuel rail.

Each fuel delivery line has an injector cup for receiving a fuel inlet portion of a respective one of the fuel injectors. The injector cup in particular shapes a recess in which the fuel inlet portion is shifted for hydraulically coupling the injector cup and the fuel inlet portion.

Each fuel delivery line further has a pipe which is arranged between the fuel rail and the injector cup for hydraulically coupling the injector cup to the fuel rail. In particular, the pipe is operable to guide the fuel from the fuel rail to the injector cup. A downstream end of the pipe is preferably hydraulically and mechanically connected to the injector cup. An upstream end of the pipe is preferably hydraulically and mechanically connected to the fuel rail, either directly or via an outlet port on the fuel rail. In the present context, the expressions “upstream” and “downstream” in particular refer to the direction of fuel flow from the fuel rail to the fuel injector.

Each fuel delivery line further comprises a fixation bracket which is configured for positionally fixing the fuel delivery line which respect to the combustion engine. In this way, the fixation bracket also contributes to positionally fixing the fuel rail assembly with respect to the combustion engine. A rigid connection is established between the fixation bracket and a portion of the pipe. This portion of the pipe is also referred to as a “fixation portion” of the pipe in the following description.

The fixation portion of the pipe is preferably spaced apart from the fuel rail and also from the fuel injector cup. Such a position of the rigid connection is particularly advantageous with regard to the mechanical stability of the fuel delivery line.

The injector cup, the pipe, and the fixation bracket are individual parts. In other words, the injector cup, the pipe and the fixation bracket are separately manufactured pieces which are fixed together only during assembly of the fuel rail assembly. Expediently, the fixation bracket may be spaced apart from the injector cup and from the fuel rail. Preferably, the fixation bracket, absent the rigid connection, is rotatable around a central axis of the fixing portion of the pipe, preferably by 360°.

In this way, the fuel rail assembly is adjustable for different engine configurations by adjusting the positions of the parts relative to one another or by exchanging only, for example, the pipe by a differently shaped or sized pipe, while retaining the design of the remaining parts. In this way, production of the fuel rail assembly may be particularly cost effective. In particular, the fixation bracket is rotatable around the fixation portion of the pipe during production of the fuel rail assembly—i.e., in particular absent the rigid connection—for adjusting the angular position of the fixation bracket relative to the fuel rail.

According to one embodiment, the fixation bracket comprises a tubular receptacle and at least one connection plate. The tubular receptacle and the at least one connection plate are separate parts which are joined together by means of at least one further rigid connection.

The tubular receptacle is preferably spaced apart from the pipe. Preferably, the at least one connection plate has a fixing portion which is remote from the tubular receptacle. The rigid connection between the fixation bracket and the pipe is preferably established between the fixing portion of the at least one connection plate and the fixation portion of the pipe.

The tubular receptacle is in particular in the shape of a straight tube, i.e., in particular of a hollow cylinder, sometimes also denoted as a cylinder shell. For example, the tubular receptacle is a steel tube. In some embodiments, the tubular receptacle is an extruded part, a cold-formed part or a turned—i.e., machined—part. In this way, the receptacle may be particularly robust and at the same time cost-effective.

The connection plate is a sheet-metal part or, in the case of a plurality of connection plates, the connection plates preferably are each individual sheet-metal parts. Preferably, each connection plate is a stamped part. In this way, the fixation bracket is particularly light-weight and can be manufactured particularly cost effectively.

In one embodiment, the fixation bracket has two connection plates which sandwich the tubular receptacle and the pipe. In a preferred development, the fixation portion of the pipe and the tubular receptacle each have a central axis, the central axes being parallel so that they define a central plane. The central axes in particular correspond to the elongation directions of the tubular receptacle and of the fixation portion of the pipe, respectively. The two connection plates are, in this case, positioned on opposite side of the central plane and preferably spaced apart from the central plane. Each of the connection plates has preferably a main plane of extension which is parallel to the central plane. The main plane of extension is in this case in particular the plane through the geometric center of gravity of the respective connection plate which is defined by the two orthogonal spatial directions in which the connection plate has its largest dimensions. In this way, the fuel delivery lines are particularly easy to assemble.

In an alternative embodiment, the fixation bracket has only one connection plate which has a U-shape as its basic shape to sandwich the tubular receptacle and the pipe between the two legs of the U-shape. In particular, the connection plate has the basic U-shape in top view along the central axis of the tubular receptacle and the fixation portion of the pipe. The legs of the U-shape are in particular positioned on opposite sides of the central plane which is defined by the central axes of the receptacle and the pipe. Either the rigid connection between the fixation bracket and the pipe or the further rigid connection between the connection plate and the tubular receptacle may be established between the connection portion of the U-shape and the receptacle or the pipe, respectively. In this case, the “connection portion” of the U-shape is the rounded portion of the U-shape which connects the two legs. A particularly stable connection may be achievable in this way. However, manufacturing the connection plate with satisfactory tolerances is more demanding in this embodiment.

In one embodiment, the connection plate or each of the connection plates has a further fixing portion which adjoins the tubular receptacle. The fixing portion(s) and/or the further fixing portion(s) are preferably shaped so that they are operable to establish a full area contact with the pipe or the tubular receptacle, respectively. In particular, the fixing portion(s) and/or the further fixing portion(s) is/are in the general shape of a section of the cylinder shell, the inner surface of the cylinder shell corresponding to an outer surface of the fixation portion of the pipe or the tubular receptacle, respectively. In this way, a particularly stable connection between the receptacle tube and the connection plate as well as between the fixation bracket and the pipe is achievable. The fixation bracket is advantageously connectable to the pipe during assembly of the fuel rail assembly in each desired angular position and at different axial positions with respect to the central axis of the pipe. In this way, the fuel rail assembly is particularly easily adjustable for different engine configurations.

In one embodiment, the at least one connection plate has at least one reinforcement bulge in a central region. The central region is positioned between the tubular receptacle and the pipe and in particular bridges the gap between the tubular receptacle and the pipe. For example, the reinforcement bulge is in the shape of a section of a cone shell. In one development, the connection plate or each connection plate has two reinforcement bulges, each of which is in the shape of a section or sections of cone shells having its vertex pointing towards the vertex of the other reinforcement bulge with the reinforcement bulges having coaxial central axes which are parallel to the central axis of the tubular receptacle and the fixation portion of the pipe.

In one embodiment, the injector cup has an indexing element for determining an angular position of the respective fuel injector relative to the injector cup. The individual parts of the fuel delivery line are preferably configured and connected in such fashion that an angular position of the fixation bracket relative to the indexing element and/or relative to the elongation direction of the fuel rail is adjustable during assembly of the fuel rail assembly. For example, the injector cup is rotatable relative to the pipe during manufacturing the fuel rail assembly and a rigid connection between the injector cup and the pipe is only established during manufacturing of the fuel rail assembly after setting a predetermined angular position of the indexing element, which may be predetermined according to the configuration of the respective engine for which the fuel rail assembly is manufactured. Analogously, the fixation bracket may be rotatable relative to the pipe before establishing the rigid connection between the fixation bracket and the pipe during manufacturing the fuel rail assembly.

In an advantageous embodiment, the rigid connection between the fixation bracket and the pipe, the rigid connection between the pipe and the injector cup, and/or the further rigid connection(s) between the at least one connection plate and the tubular receptacle is/are brazed and/or welded connections. For example, the respective connection is established by a welded pre-connection and a fluid-tight brazed connection. The welded pre-connection may be a spot-welded connection. By means of such connections, the angular positions are particularly easily adjustable during assembly of the fuel rail assembly.

In one embodiment, each fuel delivery line comprises and outlet port tube. The outlet port tube is in particular a further individual part, which is in particular manufactured separately from the injector cup, the pipe and the fixation bracket. The fixation bracket may expediently be spaced apart from the outlet port tube. The outlet port tube is preferably attached to an outer surface of the fuel rail. In particular, the outlet port tube is shaped in such fashion, that its position on the outer surface of the fuel rail is adjustable during assembly of the fuel rail assembly. For example, during manufacturing of the fuel rail assembly, the fuel rail may be provided with bores for dispensing fuel into the fuel delivery lines. The position of the bores is predetermined according to the engine configuration for which the fuel rail assembly is produced and may vary from fuel rail to fuel rail. The outlet port tubes may be positioned laterally surrounding a respective bore of the fuel rail, independent on the position of the bore in the fuel rail. The outlet port tubes are preferably attached to the outer surfaces of the fuel rail by means of a brazed and/or welded connection, in particular as detailed in the preceding paragraph.

According to a further embodiment, the fuel rail has a sensor port tube which branches off from the fuel rail. In another embodiment, the fuel rail assembly has a fixation lug for fixing the fuel rail to the internal combustion engine. The sensor port tube and/or the fixation lug is/are fixed to the outer surface of the fuel rail. The fixation may be established by a respective brazed and/or welded connection, in particular as detailed above. Preferably, the sensor port tube and/or the fixation lug is/are shaped and connected with the fuel rail in such fashion that a position of the sensor port tube and the fixation lug, respectively, on the outer surface is adjustable during assembly of the fuel rail assembly. For example, the outlet port tube, the sensor port tube and/or the fixation lug have respective connection surfaces which are congruent to a portion of the outer surface of the fuel rail.

According to a further embodiment, the fuel rail assembly comprises an inlet fitting which is received in the fuel rail and/or an end plug which is plugged into the fuel rail. Preferably, the inlet fitting and the end plug are positioned at opposite axial ends of the fuel rail. Alternatively, the fuel rail assembly may have end plugs at both axial ends of the fuel rail while the inlet fitting branches off from the outer, circumferential surface of the fuel rail. The end plug(s) may be replaced by a respective end cap which is shifted over the fuel rail. In one embodiment, the inlet fitting and/or the end plug(s) or end cap(s) are fixed to the outer surface of the fuel rail by a respective brazed and/or welded connection, in particular as detailed above. The inlet fitting and/or the end plug may also be fixed to the fuel rail by means of a brazed connection with an inner surface of the fuel rail, in particular in embodiments in which the inlet fitting and the end plug(s), respectively, are shifted into the fuel rail.

In a preferred embodiment, all connections between the individual, above mentioned parts of the fuel rail assembly are brazed and/or welded connections. For example, the connections are each established by a welded pre-connection and a fluid-tight brazed connection. The welded pre-connection may be a spot-welded connection. In this way, production of the fuel rail is particularly cost effective.

That the fixation brackets “positionally fix” the fuel delivery line with respect to the engine and the fixation lug “fixes” the fuel rail to the internal combustion engine means in particular that the fuel delivery line or the fuel rail, respectively, is held in place with respect to the combustion engine by means of the fixation bracket or the fixation lug, respectively. In particular, the fixation brackets and/or the fixation lug are coupled to the combustion engine by screws or bolts. Preferably, there are no further screw-connections between the fuel rail assembly and the combustion engine, apart from those with the fixation brackets and the fixation lug, as the case may be. This, however, is not meant to exclude the presence of other, in particular inevitable, mechanical coupling between the fuel rail and the combustion engine, e.g., through hydraulic connections such as via the inlet fitting or the fuel injectors. Preferably, however, no mechanical connection is made between the fuel rail assembly and the combustion engine—apart from the fixation brackets and the fixation lug, as the case may be—which is primarily provided for mechanically fixing the fuel rail assembly to the combustion engine.

Further advantages, advantageous embodiments and developments of the fuel rail assembly and of the method will become apparent from the exemplary embodiments which are described below in association with schematic figures.

### BRIEF DESCRIPTION OF THE DRAWINGS

In the figures:

FIG. 1 shows a schematic exploded view of a portion of an internal combustion engine with a fuel rail assembly according to a first embodiment,

FIG. 2 shows a schematic exploded view of the fuel rail assembly according to the first embodiment,

FIG. 3 shows a schematic exploded view of a fixation bracket of the fuel rail assembly according to the first embodiment,

FIG. 4A shows a schematic sectional view of the fixation bracket,

FIG. 4B shows a schematic sectional view of a fixation bracket according to a second embodiment,

FIG. 5 shows a top view of the fuel rail assembly according to the first embodiment,

FIG. 6 shows a side view of the fuel rail assembly according to the first embodiment, and

FIG. 7 shows a side view of a fuel rail assembly according to a second embodiment.

### DETAILED DESCRIPTION

In the exemplary embodiments depicted in the figures, similar, identical or similarly acting elements are provided with the same reference symbols.

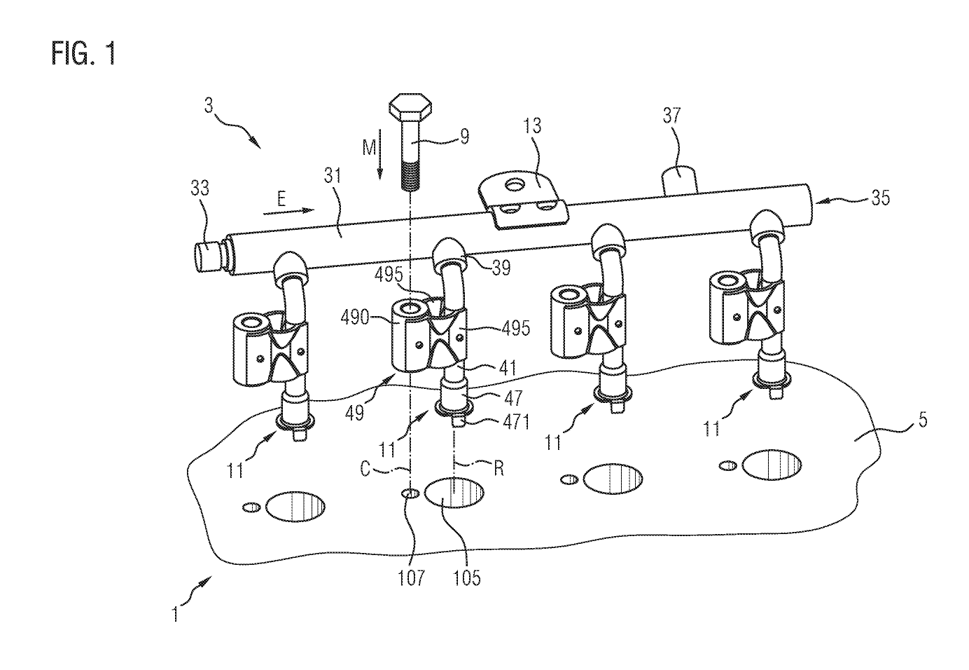

FIG. 1 shows an exploded perspective view of an internal combustion engine 1 with a fuel rail assembly 3 according to a first embodiment. The internal combustion engine 1 has a cylinder head 5 which comprises installation bores 105 for receiving fuel injectors 7 (not shown in FIG. 1).

The fuel rail assembly 3 comprises in elongated tubular fuel rail 31. For example, the fuel rail 31 is metallic, in particular it is made from steel. Fuel is supplied to the fuel rail 31 through an inlet fitting 33 on one axial end of the fuel rail 31. The opposite axial end of the fuel rail 31 is sealed by an end plug 35 (not visible in FIG. 1). The fuel rail 31 is fixed with respect to the engine 1 by means of a fixation lug 13. A sensor port tube 37 branches off from the fuel rail 31.

In addition, a plurality of fuel delivery lines 11 branch off from the fuel rail 31. The fuel delivery lines 11 are spaced apart from one another and follow one another in an elongation direction E of the fuel rail 31. The fuel delivery lines 11 are operable to connect the fuel rail 31 hydraulically to the fuel injectors 7. In an expedient embodiment, the fuel injectors 7 are also held in place by the fuel rail assembly 3.

All fuel delivery lines 11 are of identical construction. For the sake of better representation, only one of the fuel delivery lines 11 is provided with reference symbols in FIG. 1. Each fuel delivery line 11 comprises an outlet port tube 39, a pipe 41 and an injector cup 47. The outlet port tube 39, the pipe 41 and the injector cup 47 are individual, separately manufactured and separately provided parts, which are assembled during manufacturing the fuel rail assembly 3. The outlet port tube 39 is fixed to an outer surface of the fuel rail 31. The outlet port tube 39 circumferentially surrounds a bore in the circumferential wall of the fuel rail 31 so that the outlet port tube 39 is hydraulically connected to the fuel rail 31 and fuel may flow from the fuel rail 31 into the outlet port tube 39.

An upstream end of the pipe 41 is fixed to the outlet port tube 39 for hydraulically and mechanically coupling the pipe 41 to the outlet port tube 39. In one development, the upstream end is shifted through the outlet port tube 39 into the respective bore in the fuel rail 31. A downstream end of the pipe 41 is hydraulically and mechanically coupled to the injector cup 47. In this way, the injector cup 47 is hydraulically coupled to the fuel rail 31 by means of the pipe 41 and the outlet port tube 39. In one embodiment, the pipe 41 is a rigid metal tube and is, in one development, made from steel.

Each fuel delivery line 11 comprises a further individual part which is a fixation bracket 49. The fixation bracket 49 is rigidly connected to a portion of the pipe 41 between the outlet port tube 39 and the injector cup 47. This fixation portion of the pipe 41 and, thus, also the fixation bracket 49, are spaced apart from the injector cup 47 and from the outlet port tube 39 and the fuel rail 31.

The fuel delivery lines 11 are rigidly fixed to the cylinder head 5 by means of fixation elements 9 via the fixation brackets 49.

Only one of the fixation elements 9 is shown in FIG. 1. Fixation element 9 maybe a bolt, as shown in FIG. 1, or a screw, for example. The bolt which represents the fixation element 9 in the present embodiment is screwed into a threaded opening 107 of the cylinder head 5 for establishing the rigid fixation.

In the present embodiment, each fixation bracket 49 is assembled from a tubular receptacle 490 and two connection plates 495 as its individual constituent parts. The connection plates 495 are stamped metal parts which are made from a sheet-metal.

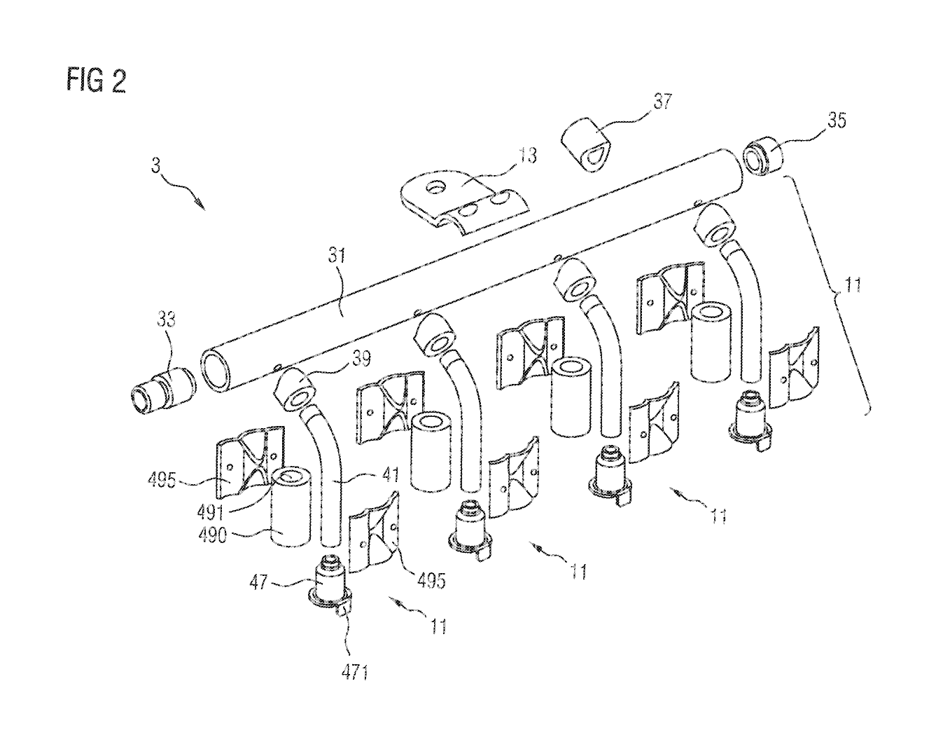

FIG. 2 shows the individual parts of the fuel rail assembly 3 in an exploded view. The individual parts are connected to one another as described above and fixed by means of rigid connections which in particular are brazed connections. It also is considerable that some or all of the connections are welded connections.

Expediently, producing the rigid connections may involve pre-connecting the individual parts by means of welded connections, in particular by spot welds, before the brazed connections are manufactured. Such pre-connections are also referred to as brazed connections in the present context.

In particular, during manufacturing of the fuel rail assembly 3, the individual parts are closely fitted to one another. Subsequently, spot-welded connections are produced at the respective joined interface regions which positionally fix the parts for the subsequent manufacturing steps. In one embodiment, a filler metal or alloy is applied at the respective joined interface regions subsequently to producing the spot-welded connections. For example in this case, the filler material may be applied in form of a paste. Alternatively, the filler metal or alloy may be applied before producing the spot-welded connections. For example in this case, the filler material may be applied in form of a self-supporting and/or dimensionally stable object, such as a ring. In one development, one of the parts comprises a recess at the interface region for accommodating the filler material object. The preassembled fuel rail assembly 3 is subsequently introduced into a furnace for melting the filler metal or filler alloy, respectively. In an expedient embodiment, copper is used as the filler material.

In this way, a rigid brazed connection is in particular established between in the fixation bracket 49 and the above mentioned portion of the pipe 41—which portion is also referred to as a fixation portion of the pipe 41 in the following—and a further rigid brazed connection is established between the tubular receptacle 490 and the connection plates 495 of the fixation bracket 49.

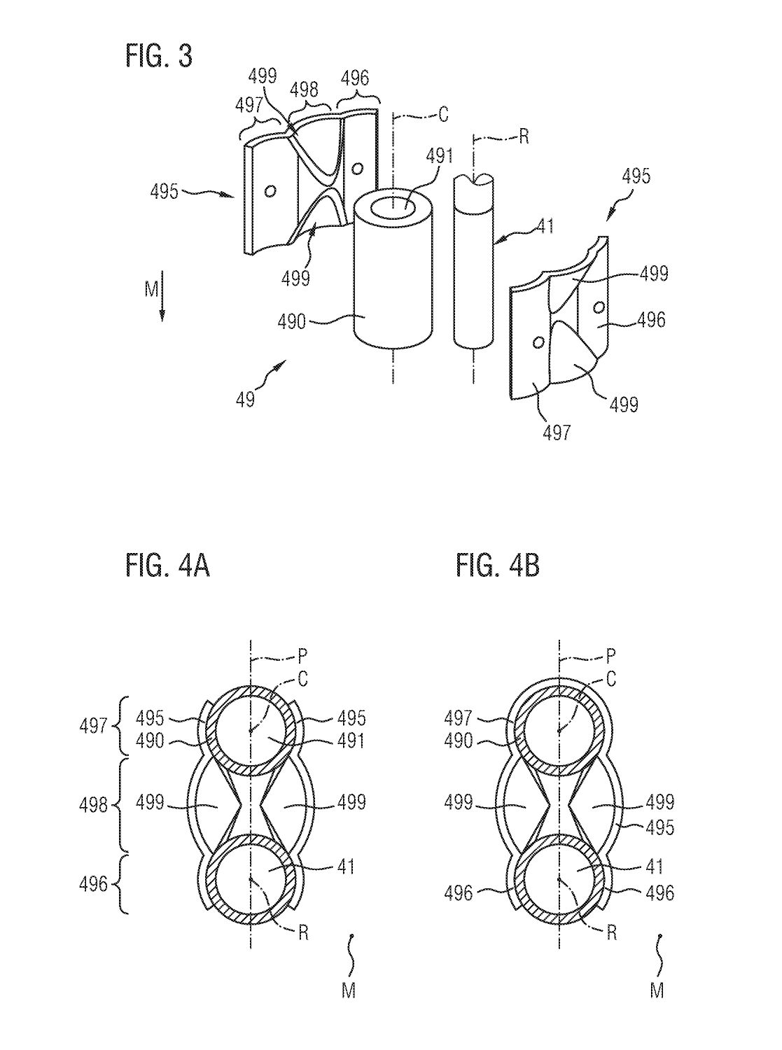

FIG. 3 shows a schematic exploded view of the fixation bracket 49. In FIG. 3 also the fixation portion of the pipe 41 is shown.

In the present embodiment, the tubular receptacle 490 is an extruded or cold-formed steel part. Tubular receptacle 490 is in the shape of a straight tube. More specifically, tubular receptacle 490 is a cylinder shell having a central axis C. The receptacle 490 is perforated in direction along the central axis C by a central opening 491 which is configured to receive the fixation element 9.

The central axis C of the receptacle 490 extends parallel to a central axis R of the fixation portion of the pipe 41. The central axis C of the receptacle 490 and the central axis R of the fixation portion of the pipe 41 are spaced apart from each other. In this way, a gap is established between the pipe 41 and the tubular receptacle 490 and the pipe 41 and the receptacle 490 are spaced apart from one another.

The central axes C, R define a central plane P. The two connection plates 495 are positioned on opposite sides of the plane P. This can be best seen in FIG. 4a, which shows a cross-sectional view of the pipe 41 and the receptacle 490 in a viewing direction along the central axes C, R.

Each connection plate 495 has a fixing portion 496 which is in the shape of a section of a cylinder shell and is in full area contact with the fixation portion of the pipe 41. In lateral direction from the central axis R of the pipe 41 to the central axis C of the receptacle 490, the fixing portion 496 is followed by central region 498 of the connection plate 495 which, in turn is succeeded by a further fixing portion 497, which is also in the shape of a cylinder shell. The further fixing portion 497 is shaped correspondingly to the tubular receptacle 490 so that the inner surface thereof is in full area contact with an outer circumferential surface of the tubular receptacle 490.

The central region 498 comprises two reinforcement bulges 499, which are in the shape of cone sections having their vertices pointing towards one another, and having cone axes which are coaxial and which are parallel to the central axes C and R of the receptacle 490 and the pipe 41, respectively.

The rigid brazed connection between the fixation bracket 49 and the pipe 41 is established between the fixing portions 496 of the connections plates 495 and the fixation portion of the pipe 41. The further rigid brazed connections between the connection plates 495 and the tubular receptacle 490 are established between the further fixing portions 497 of the connection plates 495 and the outer circumferential surface of the tubular receptacle 490.

As can be seen in FIG. 2, the injector cup 47 has an upper end portion which is shifted into the downstream end of the pipe 41 for connecting the injector cup 47 and the pipe 41. The upstream end of the pipe 41 is shifted into the outlet port tube 39.

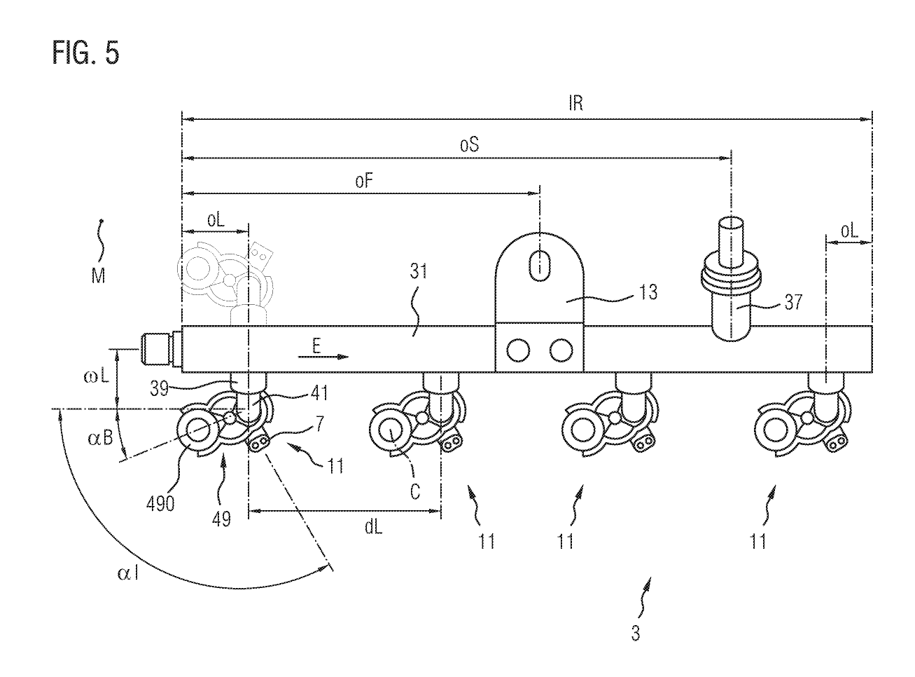

The connection surfaces of the outlet port tubes 39 which are adjoining the fuel rail 31, the connection surface of fixation lug 13 and the connection surface of the sensor port tube 37 are each portions of a cylinder surface which is congruent to the cylinder surface which will represent the outer surface of the fuel rail 31. In this way, the outlet port tubes 39, the fixation lug 13 and the sensor port tube 37 may be positioned at any desirable place on the outer surface of the fuel rail 31. Therefore, the position oL of the first outlet port tube 39, with respect to an axial end of the fuel rail 31, maybe selected during manufacturing the fuel rail assembly 3, the position of of the fixation lug 13 along the elongation direction E of the fuel rail 31 may be selected during manufacturing the fuel rail assembly 3 as well as the position oS of the sensor port tube 37 along the elongation direction E. This can be best seen in FIG. 5 which shows a top view along the central axis C of the tubular receptacle 490, which is also a mounting direction M of the fuel rail assembly 3.

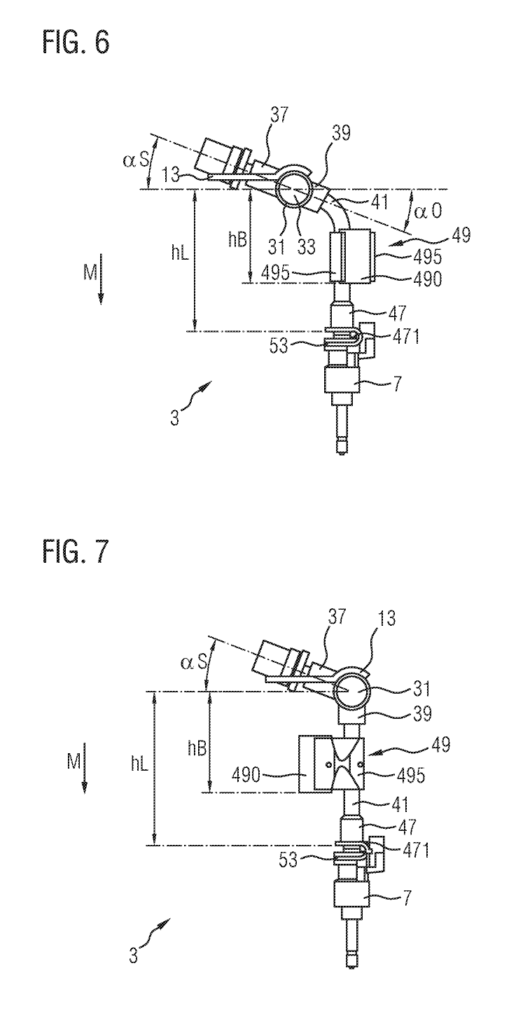

In FIG. 6, which shows a side view of the fuel rail assembly 3, it is best visible that also the elevation angles αO, αS of the outlet port tube 39 and the sensor port tube 37 relative to a plane which is perpendicular to the mounting direction M may be adjusted to a respective engine geometry during assembly of the fuel rail assembly 3. In addition, an elevation angle of the mounting lug 13 relative to that plane is adjustable.

In the present embodiment, each injector cup 47 has an indexing element 471. In the present case, the indexing element 471 is an indexing tab which axially protrudes beyond the rest of the injector cup 47 towards the fuel injector 7. The fuel injector 7 has a corresponding indexing element (not visible in the figures) to set a predetermined angular position between the injector cup 47 and the respective fuel injector 7. Before establishing of the rigid brazed connection between the pipe 41 and the injector cup 47, the injector cup 47 is rotatable relative to the pipe 41 around the central axis R so that the angular position αI of the indexing element 471 relative to the elongation direction E (cf. FIG. 5) is variable during manufacturing of the fuel rail assembly 3.

Since the fixation bracket 49 is connected to the pipe 41 only during assembling the fuel rail assembly 3 and the fixing portion 496 allows for any desired rotational orientation of the connecting plates 495 to the pipe 41, the angular position αB of the tubular receptacle 490 to the elongation direction E of the fuel rail 31 (cf. FIG. 5) is also adjustable during manufacturing the fuel rail assembly 3. The angular position αB is in particular the angle having as its legs the distance vector from the central axis R of the pipe 41 to the central axis C of the tubular receptacle 490 and the elongation direction E of the fuel rail 31.

Also the axial position hB of the fixation bracket 49 on the pipe 41 is adjustable before the rigid brazed connection between the pipe 41 and the connection plates 495 is established (cf. FIG. 6). Also, the distance dL between the individual fuel delivery lines 11 is adjustable by means of positioning the outlet port tube 39.

In addition, by means of the shape and length of the pipe 41, a lateral offset ωL of the injector cup 47—and, thus, the fuel injector 7—from the fuel rail 31 (see FIG. 5) and the distance hL of the fuel rail 31 to the fuel injector cup 47 in the mounting direction M (see FIG. 6) is adjustable. Finally also the length 1R of the fuel rail 31 may be selected.

Apart from changing the shape and length of the pipe 41 and the length lR of the fuel rail 31, all of the above mentioned adjustments in angles, positions and distances may be achieved using the same standard components. Therefore, the fuel rail assembly 3 is easily configurable in size and shape for different engines 1 with using the same parts. Therefore, a particularly cost-effective manufacturing of the fuel rail assembly 3 is achievable.

FIG. 4b shows a fuel rail assembly 3 according to a second exemplary embodiment in a sectional view corresponding to that of FIG. 4a. The fuel rail assembly 3, according to the second embodiment, corresponds in general to that of first embodiment. However, instead of two connection plates 495, the fixation brackets 49 according to this embodiment only have one single connection plate 495.

In the present embodiment, the connection plate 495 has, in the top view along the central axis C of the receptacle 490, the basic shape of the letter U. The legs of the U are positioned on opposite sides of the central plane P. The further fixing portion 497, which establishes the ridged brazed connection with the tubular receptacle 490, is represented by the intermediate portion of the U-shape which connects the legs.

It is also conceivable that the U shape is closed at the opposite end, so that the intermediated portion which connects the legs extends around the pipe 41 for establishing the rigid connection with the fixation portion of the pipe 41. This variant is not shown in the figures.

As in the first embodiment, the connection plate 495, more specifically each leg of the connection plate 495, has a central region 498. The central regions 498 bridge the gap between the pipe 41 and the receptacle 490 and each comprises two reinforcement bulges 499 which are in the shape of cone sections having their vertices pointing towards each other.

FIG. 7 shows a schematic side view of a fuel rail assembly 3 according to a third embodiment. The fuel rail assembly 3 corresponds in general to the fuel rail assembly 3 according to the first embodiment.

However, the pipe 41 is a straight tube in the third embodiment. This has the effect that the injector cup 47 is not laterally displaced with respect to the fuel rail 31, i.e. ωL=0. In contrast thereto, the pipe 41 according to the first embodiment has a straight section comprising the fixation portion and a bent section upstream of the straight section.

Embodiments have been described herein in an illustrative manner, and it is to be understood that the terminology which has been used is intended to be in the nature of words of description rather than of limitation. Obviously, many modifications and variations of the invention are possible in light of the above teachings. The description above is merely exemplary in nature and, thus, variations may be made thereto without departing from the spirit and scope of the invention as defined in the appended claims.

1. A fuel rail assembly for an internal combustion engine, comprising:
an elongated tubular fuel rail and a plurality of fuel delivery lines branching off from the fuel rail for hydraulically coupling the fuel rail to fuel injectors which are operable to inject fuel into the combustion engine, each fuel delivery line having
an injector cup for receiving a fuel inlet portion of a respective one of the fuel injectors,
a pipe being arranged between the fuel rail and the injector cup for hydraulically coupling the injector cup to the fuel rail, and
a fixation bracket which is configured for positionally fixing the fuel delivery line with respect to the engine, wherein
a rigid connection is established between the fixation bracket and a portion of the pipe, said portion being spaced apart from each of the fuel rail and the injector cup,
the injector cup, the pipe, and the fixation bracket are individual parts, and
the fixation bracket is spaced apart from the injector cup and from the fuel rail.

2. The fuel rail assembly according to the claim 1, wherein
each fuel delivery line comprises an outlet port tube which is attached to an outer surface of the fuel rail by means of a brazed or welded connection, and
the fixation bracket is spaced apart also from the outlet port tube.

3. The fuel rail assembly according to claim 1, wherein
the fixation bracket comprises a tubular receptacle and at least one connection plate,
the tubular receptacle and the at least one connection plate are separate parts which are joined together by at least one further rigid connection,
the tubular receptacle is spaced apart from the pipe, and
the rigid connection between the fixation bracket and the pipe is established between a fixing portion of the at least one connection plate, which fixing portion is remote from the tubular receptacle, and the portion of the pipe.

4. The fuel rail assembly according to claim 3, wherein the fixation bracket has two connection plates which sandwich the tubular receptacle and the pipe.

5. The fuel rail assembly according to claim 3, wherein the fixation bracket has one connection plate which has a U-shape as a basic shape thereof to sandwich the tubular receptacle and the pipe between two legs of the U-shape.

6. The fuel rail assembly according claims 3, wherein at least one of the fixing portion of the at least one connection plate and a further fixing portion of the at least one connection plate, the further fixing portion adjoining the tubular receptacle, is in a general shape of a section of a cylinder shell, and wherein for each cylinder shell, an inner surface of the cylinder shell corresponds to an outer surface of a corresponding one of the portion of the pipe and the tubular receptacle to establish a full-area contact between the cylinder shell and the corresponding one of the portion of the pipe and the tubular receptacle.

7. The fuel rail assembly according to one of claim 3, wherein the at least one connection plate has at least one reinforcement bulge in a central region between the tubular receptacle and the pipe.

8. The fuel rail assembly according to claim 3, wherein the at least one connection plate is made from sheet-metal.

9. The fuel rail assembly according claim 1, wherein the injector cup has an indexing element to set an angular position of the respective one of the fuel injectors relative to the injector cup, and the individual parts of the fuel delivery line are configured and connected in such fashion that an angular position of the fixation bracket, at least one of relative to the indexing element and relative to a elongation direction of the fuel rail, is adjustable during assembly of the fuel rail assembly.

10. The fuel rail assembly according to claim 3, wherein at least one of the rigid connection and the further rigid connection is a brazed or welded connection.

11. The fuel rail assembly according to claim 1, wherein the pipe is connected to the injector cup by a brazed or welded connection.

12. The fuel rail assembly according to claim 1, wherein the tubular receptacle has an opening perforates the tubular receptacle in a mounting direction, a central axis of the opening being parallel to a central axis of said portion of the pipe.

13. The fuel rail assembly according to claim 1, further comprising at least one of:
a sensor port tube branching off from the fuel rail, and
a fixation lug for fixing the fuel rail to the internal combustion engine, wherein
at least one of the sensor port tube and the fixation lug is fixed to an outer surface of the fuel rail by a respective brazed or welded connection, and
at least one of the sensor port tube and the fixation lug is shaped and connected to the fuel rail in such fashion that a position of the at least one of the sensor port tube and the fixation lug on the outer surface of the fuel rail is adjustable during assembly of the fuel rail assembly.

14. The fuel rail assembly according to claim 1, comprising at least one of:
an inlet fitting received in the fuel rail, and
an end plug plugged into the fuel rail, wherein the at least one of the inlet fitting and the end plug is fixed to the fuel rail by a respective brazed or welded connection.
